(19) United States
(12) Patent Application Publication
(10) Pub. No.: US 2013/0262845 A1
(43) Pub. Date: Oct. 3, 2013

(54) METHOD AND SYSTEM FOR GENERATING A STANDARDIZED SYSTEM BUILD FILE

(71) Applicants: Dana Pearson, Riverview, FL (US); Robert Fisher, Riverview, FL (US); Jason G. Huddleston, Tampa, FL (US)

(72) Inventors: Dana Pearson, Riverview, FL (US); Robert Fisher, Riverview, FL (US); Jason G. Huddleston, Tampa, FL (US)

(73) Assignee: Verizon Patent and Licensing Inc., Basking Ridge, NJ (US)

(21) Appl. No.: 13/434,372

(22) Filed: Mar. 29, 2012

(51) Int. Cl. G06F 15/177; G06F 9/00

(52) U.S. Cl. 713/1

(57) ABSTRACT

An approach for determining one or more configuration variables within a standardized input file, processing the one or more configuration variables to select one or more scripts from among a plurality of modularized scripts, and generating a standardized system build file based on the selected one or more scripts for building a system environment.

### BACKGROUND INFORMATION

Various operating systems may employ one or more methods to create and setup an operating system environment on a new computer system. For example, versions of operating systems, such as LINUX or UNIX, may be installed using software programs that allow for a large amount of configuration of the computer system during the system build process using commands and shell scripting. One such software program associated with RedHat and other versions of LINUX is Kickstart. However, all the configuration information needs to be placed in a location (e.g., a file) that is called by the software program when building the operating system environment. Configuring a file for each build process can become tedious with the large amount of information that may be associated with the file. Further, different build processes may require different information within the file such that a batch build process is not possible or takes a considerable amount of time to configure the file differently for each build process.

Based on the foregoing, there is a need for providing an efficient process to create a standardized system build file.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing a standardized and automated process to create a standardized system build file, according to an exemplary embodiment;

FIG. 2 is a diagram of a configuration platform capable of providing a standardized and automated process to create a standardized system build file, according to an exemplary embodiment;

FIG. 3 is a flowchart of a process for providing a standardized and automated process to create a standardized system build file, according to an exemplary embodiment;

FIG. 4 is a flowchart of a process for sourcing modularized scripts for generating a standardized system build file, according to an exemplary embodiment;

FIG. 5 is a flowchart of an automated build process for building an operating system environment using the standardized system build file, according to an exemplary embodiment;

FIG. 6 is user interface associated with inputting configuration variables for generating a standardized system build file, according to an exemplary embodiment;

FIG. 7 is a diagram of a computer system that can be used to implement various exemplary embodiments; and

FIG. 8 is a diagram of a chip set that can be used to implement various exemplary embodiments.

### DESCRIPTION OF THE PREFERRED EMBODIMENT

An apparatus, method, and software for providing an efficient process to create a standardized system build file, is described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

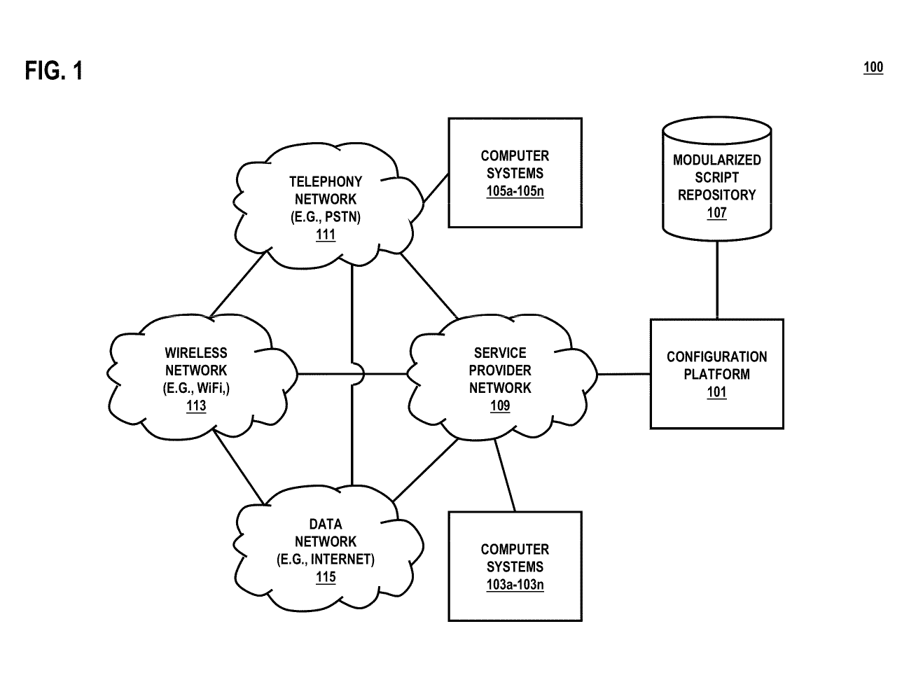

FIG. 1 is a diagram of a system 100 capable of providing a standardized and automated process to create a standardized system build file, according to one embodiment. As discussed above, various operating systems may employ a software program, such as Kickstart for versions of LINUX, that allows for a large amount of configuration of the operating system environment during the build process using commands and shell scripting. To start the build process, the computer systems (e.g., servers) involved with the build process may boot from a bootable disk image (ISO) file simulating a CD/DVD boot drive that contains the source information for the operating system environment. However, the configuration information used by the software program needs to be placed in a location that is accessible by the software program, such as in a system build file. In the case of Kickstart, Kickstart typically uses a ks.cfg file that contains all of the configuration information. Configuring each system build file for each build process can become tedious with the large amount of configuration information that may be associated with the file. By way of example, for each build process, the ks.cfg must be created according to the specific configuration of the system being built. Further, different build processes may require different information within the system build file such that batch build processes are not possible or take a considerable amount of time to configure each build file differently for each build.

The approach of the system 100 stems, in part, from the recognition that there is currently no automated solution for the installation and deployment of operating system environments for computer systems based on the current requirement of manually creating a standard build file for a build process with all of the components described.

In an effort to standardize and automate the build process, the system 100 allows for the automation of the creation of a standardized system build file and related bootable image file through a set of shell scripts. The system 100 introduces a modularized collection of scripts that are used to create a standardized system build file using a simplified and standardized input file. Consequently, the system 100 outputs the standardized system build file and a bootable image file. The standardized system build file and bootable image file can then be used to completely automate a build process of an operating system environment on a computer system.

The modularized collection of scripts allows for an automation of variations in the build process based on configuration variables that are within the simplified and standardized input file. By way of example, the modularized collection of scripts allow for the creation of operating system environments that have alternate file system sizes, different operating system versions, alternate hardware, or different sets of software installed. The configuration variables within the standardized input file allow for the sourcing of one or more scripts and the modification of the scripts during a build process by changing one or more variables within the standardized input file.

By way of the simplified and standardized input file, anyone with the basic knowledge of an operating system environment may select from the configuration variables that are used to create a customized but standardized system build file. The variables may be controlled such that any combination or selection of the variables still maintains certain standards that are required across all system environments.

By way of the bootable image file, the operating system environment may be configured in an unattended process that allows a technician to run an installation quickly and efficiently while minimizing resources, such as the valuable time of the technician. Further, the creation of the standardized system build file allows for the quick and efficient configuration of each system. By way of example, the combination of the automated creation of the standardized system build file with the bootable image file may reduce complicated tasks that would normally take several hours to half a day to take only about fifteen minutes for the first creation of an operating system environment and five minutes for each similar system thereafter.

In one embodiment, the collection of modularized scripts may be written using korn shell. However, the scripts may be written in any type of shell scripting language. In one embodiment, the scripts are written in whatever shell scripting language that is supported by the system.

The combination of the standardized system build file and the bootable image file allows for a network-based operating system environment build process. Thus, in one embodiment, only the operating system software necessary to build the operating system environment is transmitted over the network—rather than the entire build image file. The combination also allows for a greater standardization of the operating system environments by controlling the configuration variables within the standardized input file and minimizes the support for the build tools by only requiring one copy of them at a centralized location (e.g., a build server). The combination also allows for better use of resources because only one copy of each version of the operating system software is required.

As shown in FIG. 1, the system 100 includes a configuration platform 101 implemented as, for example, part of a service provider network 109 for providing a standardized and automated process to create a standardized system build file. However, in alternative embodiments, the configuration platform 101 could be implemented as any part of the system 100. The configuration platform 101 provides a user interface for collecting user inputs regarding configuration variables. The configuration platform 101 may then generate a standardized input file that contains the selected configuration variables. However, in one embodiment, the configuration platform 101 may bypass generating a standardized input file and instead directly process the configuration variables from the user interface. However, by creating the standardized input file, a user may later edit the file rather than creating a new standardized input file using the user interface.

The configuration platform 101 then processes the standardized input file and the configuration variables associated with the standardized input file to select one or more scripts from a number of modularized scripts. The modularized scripts allow for the creation of an operating system environment according to any number of ways based on any combination of the configuration variables provided. The configuration platform 101 then generates a standardized system build file based on the selected scripts. The configuration platform 101 further generates a bootable image file based on the configuration variables. The configuration platform 101 then connects the bootable image file to the computer system being built by the build process. The computer system may then boot from the bootable image file retrieve the standardized system build file generated from the selected scripts to determine how to build the server. Based on the standardized system build file, software packages that are used to build the operating system environment are transmitted to the computer system for installation and configuration on the computer system.

The system 100 further includes computer systems 103a-103n (collectively referred to as computer systems 103) and 105a-105n (collectively referred to as computer systems 105). As illustrated, the computer systems 103 may be associated with the service provider network 109, and the computer systems 105 may be associated with the telephony network 111. Further computer systems (not shown) may be associated with the wireless network 113 and/or the data network 115. By way of example, the computer systems 103 and 105 may be one or more servers that are used to implement the networks 109-115 and/or any functionality within the networks. However, the computer systems 103 and 105 may be any type of computer systems that are associated with any of the networks 109-115. In various embodiments, the system 100 may encompass numerous computer systems 103 and 105. Further, the computer systems 103 and 105 may require the provisioning of operating system environments to implement the various computer systems 103 and 105 within the system 100. Accordingly, for large systems, there may be a large number (e.g., hundreds, or thousands) of computing platforms that need to be provisioned with an operating system environment.

The system 100 may further include a modularized script repository 107. The modularized script repository 107 may include the modularized scripts that are used by the configuration platform 101 to generate the standardized system build files. However, in one embodiment, the modularized scripts may be associated directly within the configuration platform 101, or may be associated with any one of the computer systems 103 or 105 associated with the system 100. By way of example, one of the computer systems 103 (e.g., a build server) may include the modularized scripts. In such an embodiment, the build server may also contain the software packages used in the build process, as well as any post configuration information, middleware, and/or firmware that may be used during the build process.

The service provider network 109 can interact with one or more other networks, such as a telephony network 111, a data network 115, and/or a wireless network 113. For illustrative purposes, the networks 109-115 may be any suitable wireline and/or wireless network, and be managed by one or more service providers. For example, telephony network 111 may include a circuit-switched network, such as the public switched telephone network (PSTN), an integrated services digital network (ISDN), a private branch exchange (PBX), or other like network. Wireless network 113 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 115 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 109-115 may be completely or partially contained within one another, or may embody one or more of the aforementioned infrastructures. For instance, the service provider network 109 may embody circuit-switched and/or packet-switched networks that include facilities to provide for transport of circuit-switched and/or packet-based communications. It is further contemplated that networks 109-115 may include components and facilities to provide for signaling and/or bearer communications between the various components or facilities of system 100. In this manner, networks 109-115 may embody or include portions of a signaling system 7 (SS7) network, or other suitable infrastructure to support control and signaling functions.

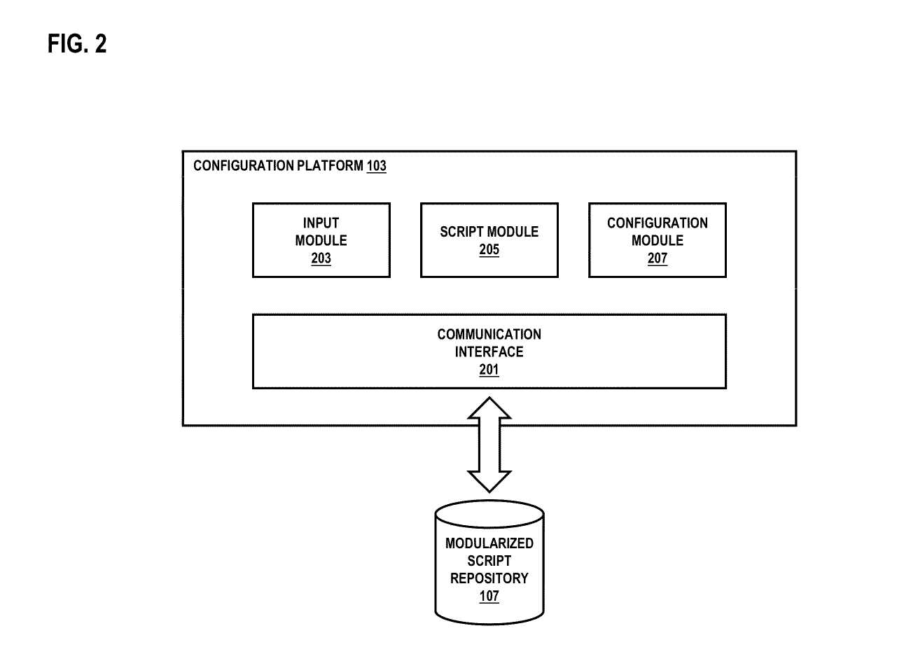

FIG. 2 is a diagram of the components of a configuration platform 101, according to an exemplary embodiment. By way of example, the configuration platform 101 includes one or more components for providing a standardized and automated process to create a standardized system build file. It is contemplated that the functions of these components may be combined in one or more components or performed by other components of equivalent functionality. In one embodiment, the configuration platform 101 includes a communication interface 201 that allows the configuration platform 101 to communication with the other elements of the system 100, including the modularized script repository 107. The configuration platform 101 may also include an input module 203, a script module 205, and a configuration module 207.

In one embodiment, the input module 203 generates or interfaces with one or more user interfaces for collecting the configuration variables. In one embodiment, the input module 203 generates and/or interfaces with a web-based user interface that allows a user to select via the Internet or an intranet the configuration variables used in generating a standardized system build file. However, the web-based user interface may be any type of graphical user interface that is web-based or non-web-based. In one embodiment, the input module 203 generates and/or interfaces with a command line-based interface that allows a user to enter the configuration variables via a command line. In one embodiment, the input module 203 generates a standardized input file based on the selected configuration variables. The standardized input file may be in any human-readable format, such as a text file or an xml file. As such, a user is able to edit the standardized input file after being created. Accordingly, a user may duplicate the standardized input file and make minor changes to the file for different build processes. By way of example, if various build processes are identical but for the Internet Protocol address of the computer systems, a user may generate a single standardized input file and duplicate the file while editing the file to change the various addresses. Subsequently, the input module 203 sources the one or more standardized input files to determine the configuration variables from within the one or more files.

In one embodiment, upon the input module 203 determining the configuration variables from within the one or more standardized input files, the script module 205 processes the various configuration variables to determine the various modularized scripts to select from within the modularized script repository 107 to use to generate the standardized system build file. However, in one embodiment, the input module 203 may interface with the user interfaces to determine the configuration files without generating a standardized input file. Rather, the configuration variables may be directly sourced from the input module 203 to the script module 205. By way of example, one or more of the configuration variables may be associated with one or more of the modularized scripts such that a selection of one of the configuration variables amounts to a selection of the corresponding modularized script.

In one embodiment, the configuration module 207 processes the selected modularized scripts to generate the standardized system build file. Generally, the configuration module 207 generates the standardized system build file by collecting all of the scripts determined from the script module 205. As discussed above, the scripts may be associated with header information of the standardized system build file, may be associated with standards information associated with the computer system, may provide scripts that retrieve software packages to be installed on the computer system, may involve post installation configuration, and may retrieve and configure middleware and/or firmware. In one embodiment, additional information may be provided within the configuration variables associated with post installation of the operating system environment. The ability to provide additional information regarding the post installation allows the build process to be more specific for the type of operating system environment regarding specific application component. Further, in one embodiment, additional information may be provided within the configuration variables associated with the middleware and firmware.

In one embodiment, the configuration module 207 further determines based on the configuration variables information pertaining to the bootable image file used during the build process. By way of example, for the computer system 103 and 105, there may be various versions of the operating system that are used. Thus, one of the configuration variables may indicate the intended version of the operating system. Based on this information, the configuration module 207 may determine the version of the bootable image file that is used during the build process to boot the computer system from to initiate the build process at the computer system.

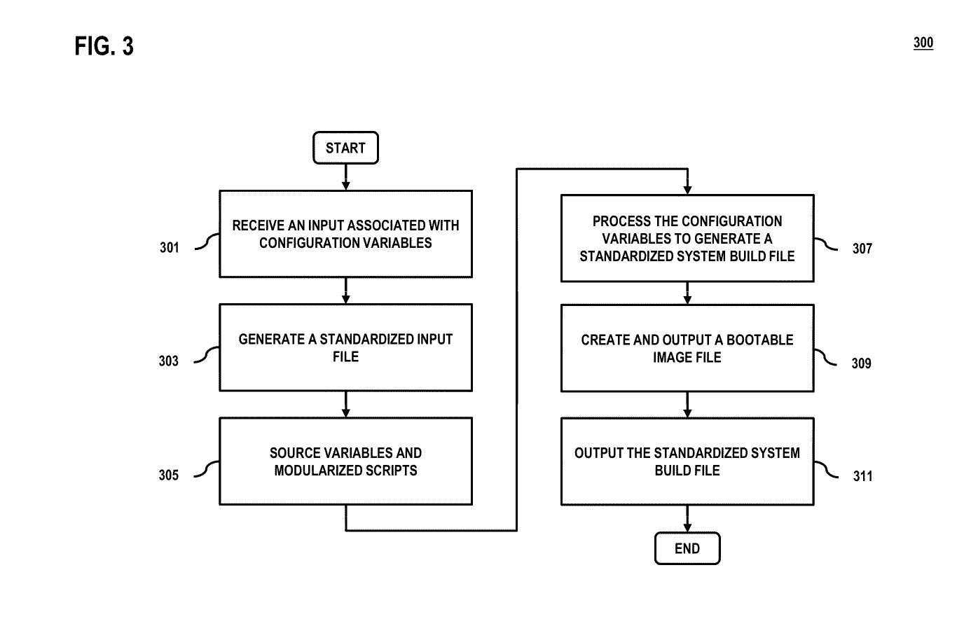

FIG. 3 is a flowchart of a process for providing a standardized and automated process to create a standardized system build file, according to an exemplary embodiment. In one embodiment, the configuration platform 101 performs the process 300 of FIG. 3. In step 301, the configuration platform 101 receives one or more inputs associated with one or more configuration variables from a user interface. As discussed above, a user may use a web interface or a command-line interface to select or indicate one or more configuration variables. By way of example, a graphical web-based interface may include several fields that include drop down menus and/or fill-in fields that allow a user to select from one or more configuration variables for various fields and type in additional information. The configuration variables may be associated with, for example, an operating system version, a domain name associated with the operating system environment and/or or computer system, an internal name or identification associated with the computer system, an external name or identification associated with the computer system, such as an Internet Protocol (IP) address, information pertaining to gateway, a time zone, a primary DNS, etc. that are associated with and/or define the operating system environment and/or computer system associated with the build process.

In step 303, the configuration platform 101 generates a standardized input file that includes the configuration variables selected from step 301 above. By way of example, the standardized input file may be a text file that includes the configuration variables that were selected by the user. In one embodiment, the standardized input file may be in the form of XML or any other human-readable language or code that may be modified and/or edited. In one embodiment, a user may edit the standardized input file directly. By way of example, where multiple operating system environments are being created for multiple build processes, a user may make minor edits to the standardized input files to account for slight differences between the operating system environments and/or the computer systems, such as incremental differences in the IP address associated with the various computer systems. However, in one embodiment, the user interface associated with step 301 may be configured such that small and/or iterative changes may be performed by the user interface. By way of example, certain fields may be associated with a value and/or a range of values and an increment associated with the range.

Subsequently, at step 305, the configuration platform 101 sources the standardized input file and the configuration variables that are contained within the standardized input file. The configuration platform 101 further sources the modularized scripts from the modularized script repository 107 to correlate the modularized scripts with the configuration variables.

At step 307, the configuration platform 101 processes the configuration variables to generate a standardized system build file. Based on the configuration variables, the configuration platform 101 selects one or more scripts from the modularized scripts within the modularized script repository 107. As discussed in detail below, the scripts may be associated with, for example, header information and setting up standardized settings such as network information, disk configuration information, etc. The scripts may be further associated with different software packages that are necessary to setup the operating system environment of the computer system. The scripts may also be associated with post installation configuration, such as post installation configuration of network configurations, server configurations, adding users, etc. In one embodiment, the scripts may be associated with adding and/or configuring middleware software and/or firmware.

In one embodiment, at step 309, the configuration platform 101 may create and output a bootable image file based on the configuration variables contained in the standardized input file. The bootable image file may be generated based on, for example, the operating system version that is associated with a configuration variable. In one embodiment, the configuration platform 101 may determine a pre-created bootable image file located within the system 100 (e.g., at a computer system 103a acting as a build server) and retrieve the bootable image file based on one or more configuration variables. The bootable image file may contain a minimum amount of information that is required to boot the computer system associated with the operating system environment build process in order to subsequently retrieve more information, as discussed in detail below.

Upon processing the configuration variables to generate a standardized system build file, at step 311, the configuration platform 101 outputs the standardized system build file.

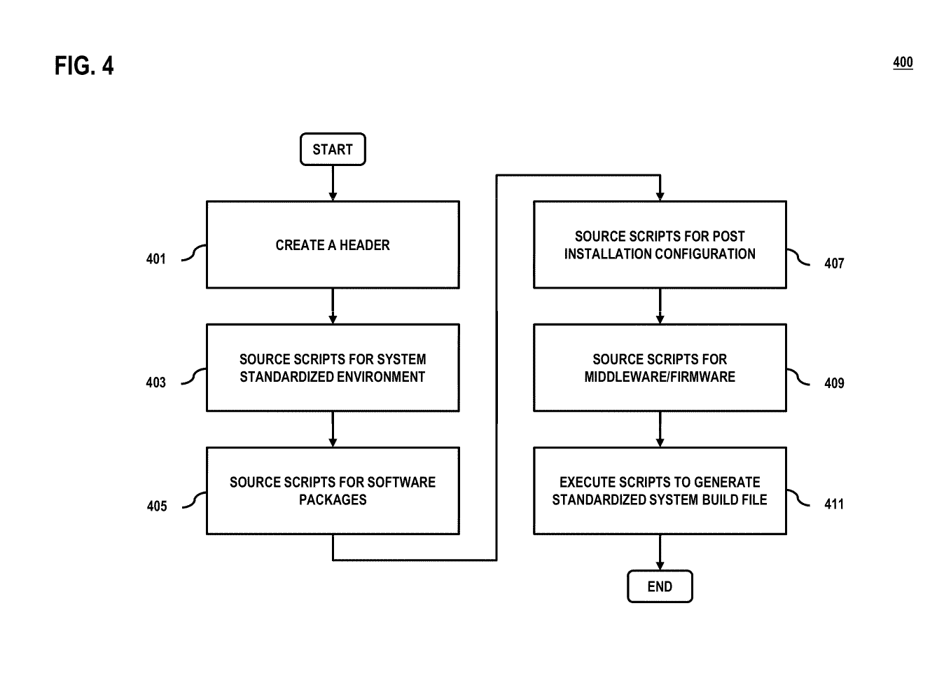

FIG. 4 is a flowchart of a process for sourcing modularized scripts for generating a standardized system build file, according to an exemplary embodiment. In one embodiment, the configuration platform 101 performs the process 400 of FIG. 4. In step 401, the configuration platform 101 generates a header script for the standardized system build file. The header script may include the basic information related to the operating system environment. By way of example, the header script may include the path to the build server, and may require any additional information that may be associated with initiating the build process.

Subsequently, in step 403 the configuration platform 101 may source one or more modularized scripts to setup standardized environment information, such as modularized scripts associated with initial network configuration that define, for example, time zone information, the IP address information, gateway information, primary DNS information, a server name and/or a host name, etc. The modularized scripts associated with the standardized environment information may also be associated with disk configuration information that define the file system, the disk configuration, the number of logical drives, a platform make, a SWAP file, etc.

In step 405, the configuration platform 101 sources scripts for to retrieve and configure various software packages that are used in the build process to configure the operating system environment.

Subsequently, in step 407, the configuration platform 101 sources scripts for post installation environment configuration. The post installation environment configuration may include additional information pertaining to the network configuration associated with the operating system environment and the computer system. By way of example, the scripts may be associated with defining a local host, various IP address for various additional information, such as various IP addresses within the system 100 that the computer system of the build process must understand to properly communicate within the system 100. The post installation configuration network scripts may also define treatment associated with information on IP version 4 IP version 6 information, such as whether the computer system is enabled to be compatible within an IPV6 environment, etc. The post installation environment configuration may include any additional information pertaining to any configuration associated with the operating system environment and the computer system such as defining various services and/or configuring environment settings and defining users associated with the computer system and/or operating system environment and the passwords associated with the users accessing the operating system environment.

Subsequently, in step 409, the configuration platform 101 sources scripts for adding and/or configuring middleware software and/or firmware. Such middleware may be additional software packages that are retrieved and loaded onto the computer system. The middleware can be any type of middleware associated with an operating system environment and computer system. The ability to change the configuration variables allows for any type or combination of middleware to be installed within the operating system environment. Additionally, the scripts associated with the middleware may be modified or changed to allow for new middleware to be installed on new computer systems without having to change, for example, an entire bootable image file and distribute the changed file to every new computer system. By way of example, the middleware may be associated with security middleware and/or system monitoring middleware. The firmware can similarly be any type of firmware associated with the hardware within a computer system. Scripts may therefore be added to ensure that the hardware associated with a computer system is updated to the latest firmware at the time of the build process. In one embodiment, the standardized system build file is configured to execute the one or more scripts associated with the middleware and/or the firmware after an initial boot after the post installation process. Subsequently, at step 411, the configuration platform 101 executes the sourced scripts to generate a standardized system build file.

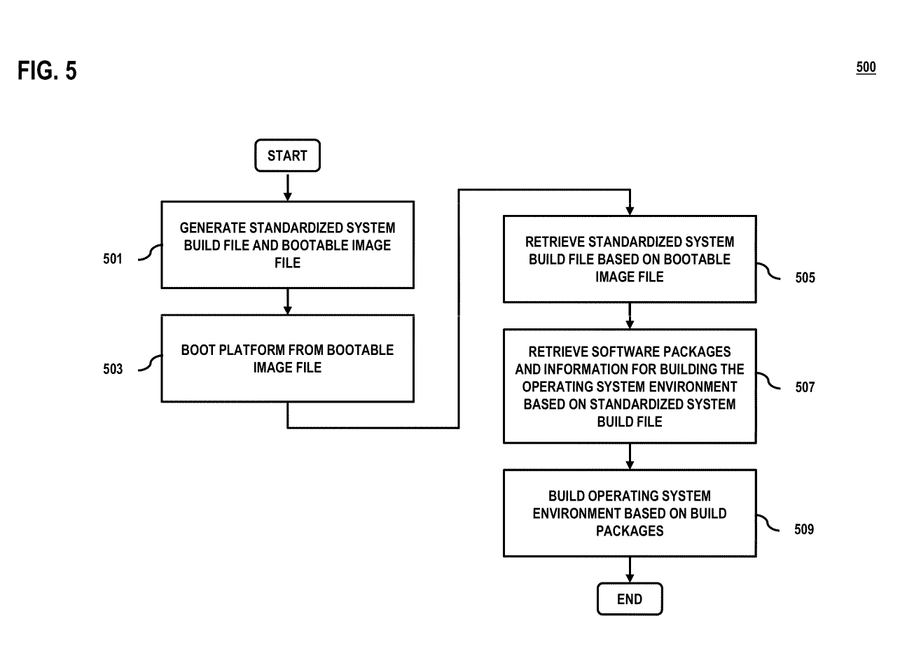

FIG. 5 is a flowchart of an automated build process for building an operating system environment, according to an exemplary embodiment. In one embodiment, the configuration platform 101 performs the process 500 of FIG. 5. In step 501, the configuration platform 101 generates a standardized system build file and bootable image file based on the above discussion. Then, at step 503, the bootable image file is sent to the computer system that is the subject of the build process. The computer system subsequently boots based on the bootable image file. In one embodiment, the computer system is connected to or associated with a virtual CD/DVD boot drive that boots the computer system from the bootable image file. The bootable image file includes, for example, the minimum necessary information required to boot the computer system. The bootable image file also includes a path to the standardized system build file. By way of example, the standardized system build file may be located at a centralized location, such as a build server, within the service provider network 109 (or anywhere else within the networks 109-115). The bootable image file includes instructions, such as the name and the path, for the computer system to load the standardized system build file that was created at step 501. The computer system the retrieves the standardized system build file based on the instructions in the bootable image file (step 505).

In step 507, the computer system executes the standardized system build file based on the software program that is associated with the installation of the operating system begins to retrieve the necessary software packages and configuration information for configuring the operating system environment based on the standardized system build file. At step 509, the computer system begins to build the operating system environment as instructed based on the standardized system build file in combination with the bootable image file. By way of example, the computer system begins configuring the network adapter/module, the disk configuration, the file system, etc. associated with the scripts for the standardized environment information. The computer system subsequently begins retrieving the software packages associated with the operating system environment according to the software package scripts. Because the scripts control the software packages that the computer system retrieves, the scripts allow for only the necessary software packages to be transmitted to the computer system. Thus, unnecessary software packages do not need to be transmitted to the computer system, therefore freeing up otherwise unnecessary bandwidth usage of the network environment. According to the scripts that were used to generate the standardized system build file, in one embodiment, post installation configuration information may be received based on the standardized system build file that further configures the network and other computer system configurations based on the software packages received. Further, in one embodiment, the middleware and/or firmware are transferred to the computer system and used in the operation system environment build process to configure the various middleware and/or firmware that are used by the computer system. In one embodiment, the middleware and firmware are transmitted to the computer system after the computer system performs an initial boot process. Subsequently, the operating system environment and the computer system are configured based on the standardized system build file and the bootable image file.

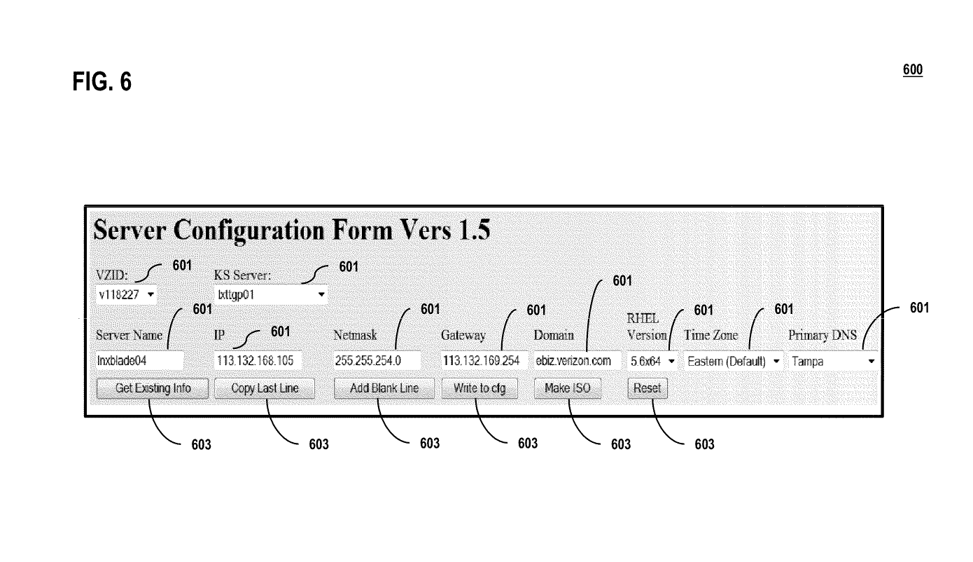

FIG. 6 is user interface associated with inputting configuration variables for generating a standardized system build file, according to an exemplary embodiment. As illustrated, the user interface 600 includes various fields 601, including drop-down menu fields (associated with the arrowheads within the fields) and fill-in fields (associated with the non-arrowhead fields). The drop-down menu fields allow a user to select one or more entries within the menu. Thus, the drop-down menu fields allow a user to select one or more configuration variables from one or more pre-defined configuration variables. The fill-in fields allow a user to enter more customizable configuration variable information, such as an IP address, a gateway address, a domain name, etc. The user interface 600 further includes action buttons 603 that provide actions that a user may initiate by selecting one of the action buttons 603. By way of example, a user may create a bootable image file based on the entered configuration variables according to the Bootable ISO action button 603. Further, the user may generate a standardized system build file based on, for example, the Write to cfg action button 603. The various other action buttons may perform additional actions, such as resetting the user interface, getting existing information, copying a line, adding a blank like, etc. In one embodiment, the user interface 600 may include an action button that allows for the creation of a standardized input file that may be edited manually by the user, such as a text file. Based on, at least in part, the user interface 600, a user may generate a standardized system build file and a bootable image file based on a simplified input method to quickly and efficiently perform the build process over multiple different types of computer systems and operating system environments within a system 100.

The processes described herein for creating a standardized system build file may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

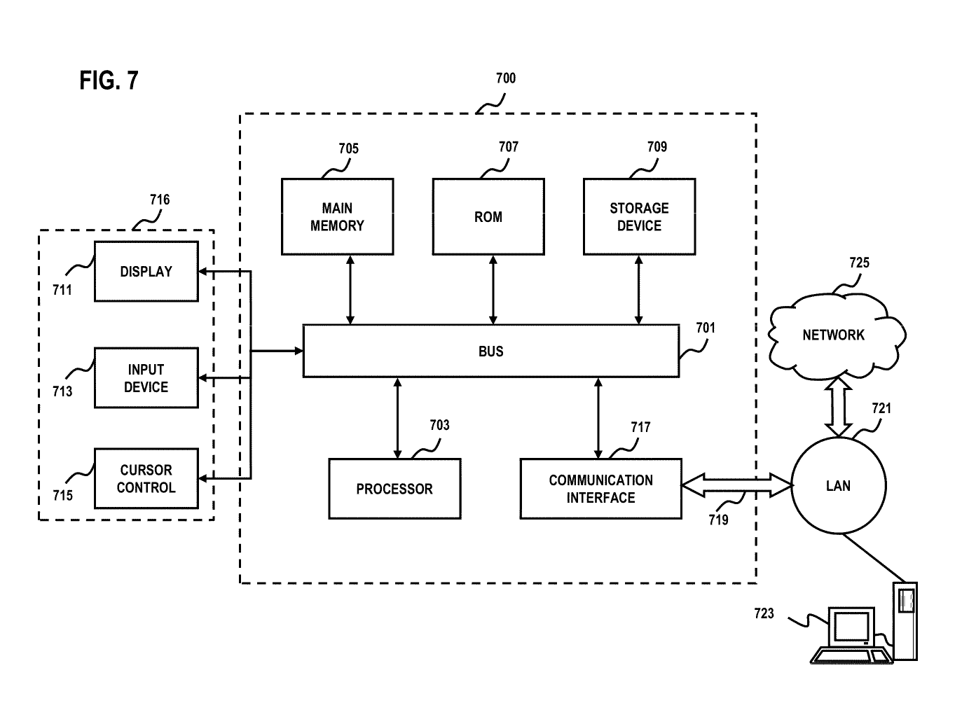

FIG. 7 illustrates computing hardware (e.g., computer system) upon which an embodiment according to the invention can be implemented. The computer system 700 includes a bus 701 or other communication mechanism for communicating information and a processor 703 coupled to the bus 701 for processing information. The computer system 700 also includes main memory 705, such as random access memory (RAM) or other dynamic storage device, coupled to the bus 701 for storing information and instructions to be executed by the processor 703. Main memory 705 also can be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for controlling cursor movement on the display 711. In one embodiment, one or more of the display 711, the input device 713 and the cursor control 715 may constitute a console device 716.

According to an embodiment of the invention, the processes described herein are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. Thus, embodiments of the invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Model (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIG. 7, multiple communication interfaces can also be employed.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an embodiment of the invention through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

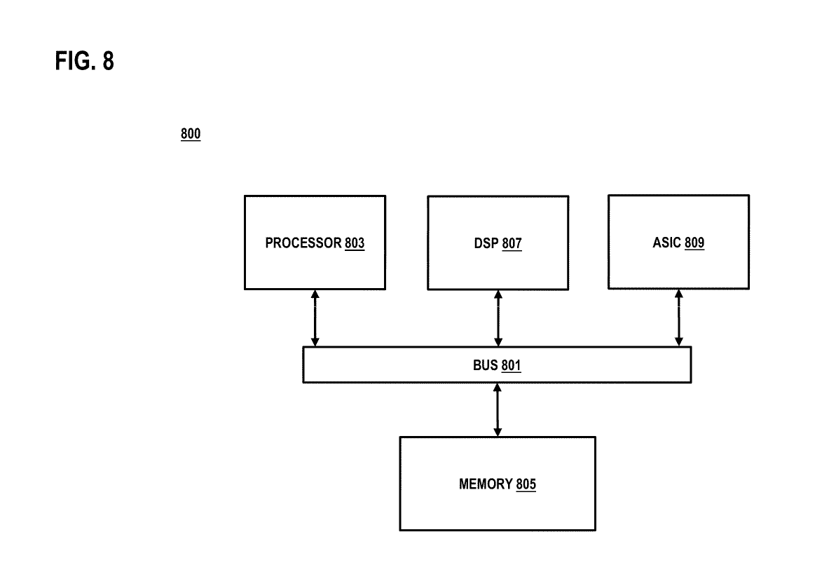

FIG. 8 illustrates a chip set 800 upon which an embodiment of the invention may be implemented. Chip set 800 is programmed to present a slideshow as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 800, or a portion thereof, constitutes a means for performing one or more steps of FIGS. 3-5.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 805 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
determining one or more configuration variables within a standardized input file;
processing the one or more configuration variables to select one or more scripts from among a plurality of modularized scripts; and
generating a standardized system build file based on the selected one or more scripts for building a system environment.

2. A method according to claim 1, further comprising:
modifying the selected one or more scripts based on the configuration variables.

3. The method according to claim 1, further comprising:
determining the selected one or more scripts based on a system version associated with the configuration variables.

4. The method according to claim 1, further comprising:
determining the selected one or more scripts based on a post configuration variable included within the one or more configuration variables.

5. The method according to claim 1, further comprising:
determining the selected one or more scripts based on a configuration variable specifying at least one of middleware and firmware associated with the system environment.

6. The method according to claim 1, further comprising:
generating a bootable image file based on the one or more configuration variables.

7. The method according to claim 5, further comprising:
retrieving the standardized system build file over a network based on the bootable image file; and
retrieving software packages from a centralized location based on the standardized system build file.

8. The method according to claim 1, further comprising:
performing a batch system environment build of multiple platforms based on the standardized system build file.

9. The method according to claim 1, wherein the standardized input file comprises a text file generated based on a web-based user interface.

10. An apparatus comprising:
a processor configured to determine one or more configuration variables within a standardized input file, process the one or more configuration variables to select one or more scripts from among a plurality of modularized scripts, and generate a standardized system build file based on the selected one or more scripts for building a system environment.

11. The apparatus according to claim 10, wherein the processor is further configured to modify the selected one or more scripts based on the configuration variables.

12. The apparatus according to claim 10, wherein the processor is further configured to determine the selected one or more scripts based on a system version associated with the configuration variables.

13. An apparatus according to claim 10, wherein the processor is further configured to determine the selected one or more scripts based on a post configuration variable included within the configuration variables.

14. An apparatus according to claim 10, wherein the processor is further configured to determine the selected one or more scripts based on a configuration variable specifying at least one of middleware and firmware associated with the system environment.

15. An apparatus according to claim 10, wherein the processor is further configured to generate a bootable image file based on the configuration variables.

16. The apparatus according to claim 15, wherein the processor is further configured to request the standardized system build file from a centralized location based on the bootable image file, and request software packages from the centralized location based on the standardized system build file.

17. The apparatus according to claim 10, wherein the processor is further configured to perform a batch system environment build of multiple platforms based on the standardized system build file.

18. An apparatus according to claim 10, wherein the standardized input file comprises a text file generated based on a web-based user interface.

19. A system comprising:
a configuration platform configured to determine one or more configuration variables within a standardized input file, process the one or more configuration variables to select one or more scripts from among a plurality of modularized scripts, generate a standardized system build file based on the selected one or more scripts for building a system environment, and generate a bootable image file based on the configuration variables,
wherein the bootable image file is accessible by a computer system configured to boot from the bootable image file.

20. The system according to claim 19, wherein the computer system is further configured to request the standardized system build file based on the bootable image file, and request software packages from the centralized location based on the standardized system build file.
